(19) United States
(12) Patent Application Publication
(10) Pub. No.: US 2020/0247726 A1
(43) Pub. Date: Aug. 6, 2020

(54) Process for Making Granules and Agglomerates from Powders

(71) Applicant: Power Minerals Limited, Sutton Coldfield (GB)

(72) Inventors: Leslie James Drury, Sutton Coldfield (GB); Michael Robert Gay, Sutton Coldfield (GB)

(73) Assignee: Power Minerals Limited, Sutton Coldfield (GB)

(21) Appl. No.: 15/780,761

(22) PCT Filed: Dec. 5, 2016
(86) PCT No.: PCT/EP2016/079789

§ 371 Date: Jun. 1, 2018

(30) Foreign Application Priority Data
Dec. 3, 2015 (EP) 15197858.2

(51) Int. Cl. C05G 1/00; C05G 5/12; C05D 9/00; C05B 11/10; C05B 11/08; C05D 3/02; C05D 5/00; C05B 19/00

(52) U.S. Cl. CPC C05G 1/00; C05G 5/12; C05D 9/00; C05B 19/00; C05B 11/08; C05D 3/02; C05D 5/00; C05B 11/10

(57) ABSTRACT

A method of processing a powder, comprising
(a) contacting the powder with
   (i) a 2-40% by weight solution of a sulphur- or phosphorous-containing mineral acid or a mixture thereof, or
   (ii) one or more alkaline earth metal oxides, carbonates or hydroxides, or a mixture thereof;
(b) combining the product of (a)(i) with one or more alkaline earth metal oxides, carbonates or hydroxides, or a mixture thereof; or combining the product of (a)(ii) with a 2-40% by weight solution of a sulphur- or phosphorous-containing mineral acid or a mixture thereof and optionally with further of the alkaline earth metal oxides, carbonates or hydroxides, or a mixture thereof; and
(c) granulating the combination of (b) to form granules.

Phosphate- and potassium-containing fertilisers are made using the granules.

This application is a U.S. national stage application filed pursuant to 35 U.S.C. § 371 from International Patent Application PCT/EP2016/079789, filed on Dec. 5, 2016 which claims the benefit of priority and the filing date of European Patent Application EP 15197858.2, filed on Dec. 3, 2015, the content of each of which is hereby incorporated by reference in its entirety.

### INTRODUCTION

This present invention relates to the treatment of ashes, dusts and powders to produce granules and similar agglomerated products.

### BACKGROUND TO THE INVENTION

Powders and dusts such as those produced from the calcination of bone and offal to produce bone meal ash, ashes from the combustion of paper, ashes from the combustion of straws, ashes from the combustion of poultry litter, ashes from the combustion of other biomasses, dusts from cement kilns, powders and dusts from the processing of potash are all examples of powders and dusts which have issues associated with their format, namely consisting of or giving rise to significant volumes of dust, creating a nuisance.

Furthermore, their usage as an agricultural product, for example in land spreading, is difficult, as they cannot be applied accurately, instead requiring specialist equipment to do so. This can be wasteful as well as raising the capital cost of their usage, the net result being lower values achieved by the product if used at all.

Many ashes and dusts have little or no further use and therefore it would be desirable to convert these powders into more industrially useful products.

For example, bone meal powder can be processed, though it is problematic to process because it is not possible to form a hard, stable granule from the powder without using a binder. As an example, it is known to use a clay (e.g. Bentonite) in amounts of approximately 40% by weight in combination with bone meal powder. This produces wet granules which require drying, a time consuming and expensive step, before they can be used for spreading, but the nutrient value is decreased and the Bentonite has a cost and no additional nutrient value.

It is also known to treat ash that has been contaminated, e.g. with chromium (at high oxidation states) from wood paint or wood worm treatment, in admixture with farm slurries, with acid at high concentration and then alkali at high concentration. This combination produces significantly exothermic reactions and uses powerful reducing and oxidising steps to detoxify the waste, reducing incidence of high oxidation state metals and destroying organic contaminants in the slurries. One such process is the subject of WO 2013/108041. This technology works well but requires concentrated acids and alkalis and is designed for contaminated feedstocks and otherwise toxic organic waste.

EP 2062013 A (BSH Umweltservice AG) describes a process of phosphorous recovery from sewage sludge ash and similar phosphorous-containing products or waste.

DE 102013018650 B3 (Remondis Aqua GmbH & Co. KG) discloses a process for treating phosphate-containing ash by wet chemical digestion to obtain aluminium, calcium, phosphorous and nitrogen.

EP 1918226 A2 (Murakashi Lime Industrial Co., Ltd) describes a phosphorous containing fertilizer which is made by improving the solubility of phosphate compounds in incinerated ashes.

CH 697 083 A5 (Eberhard Recycling AG) describes a method of recovering phosphorous from combustion ash.

DE 10206347 A1 (IBU-tec GmbH & Co. KG) also describes a method of recovering phosphorous from combustion ash.

The above generally disclose contacting the ash with a mineral acid to remove various impurities and/or increase the solubility of the phosphorous containing compounds. The solubilised phosphorous compounds can then be precipitated from solution. These documents do not, however, disclose a fertiliser which can be spread using conventional granule spreading equipment.

WO 2015/132261 A1 (Yara International ASA) describes a method of coating ammonium nitrate particle with an inorganic coating. The resulting particles are described as being useful as fertilisers.

US 2007/0062232 A1 (Murakashi Lime Industrial Co., Ltd) discloses a method of producing novel phosphate containing fertilisers showing good handleability from incinerated ashes. However, this process requires the use of harsh chemical conditions (namely, high concentration mixtures of phosphoric and sulphuric acid) in order to produce the desired fertilisers

Therefore, there exists a need for alternative, preferably improved methods of granulating ashes, dusts and powders, preferably to produce products with increased nutrient value, which can be spread using conventional granule spreading equipment.

### THE INVENTION

It is an object of the present invention to provide an improved and economically viable process whereby powders, especially ashes and dusts, can be treated yielding granulated and/or agglomerated products without the use of additional binders such as clays or polymers.

It is a further optional object of the present invention that these powders can have other materials included with them as desired to enhance the beneficial properties of the so produced granule or agglomerate, for example in agricultural products.

Accordingly, the invention provides a method of processing a powder, comprising
(a) contacting the powder with
   (i) a 2-40% by weight solution of a sulphur- or phosphorous-containing mineral acid or a mixture thereof, or
   (ii) one or more alkaline earth metal oxides, carbonates or hydroxides, or a mixture thereof;
(b) combining the product of (a)(i) with one or more alkaline earth metal oxides, carbonates or hydroxides, or a mixture thereof; or combining the product of (a)(ii) with a 2-40% by weight solution of a sulphur- or phosphorous-containing mineral acid or a mixture thereof and optionally with further of the alkaline earth metal oxides, carbonates or hydroxides, or a mixture thereof; and
(c) granulating the combination of (b) to form granules.

The order of steps can optionally be varied, provided that the acid solution is not combined with the alkaline earth metal compound(s) prior to mixing of the powder with one of these or with at least part of the alkaline earth metal compound(s). Hence, in an embodiment, the method of processing a powder comprises (a) contacting the powder with a solution of a sulphur- or phosphorous-containing mineral acid or a mixture thereof; (b) combining the product of (a) with one or more alkaline earth metal oxides, carbonates or hydroxides, or a mixture thereof; and (c) granulating the combination of (b) to form granules.

In a further embodiment, the method of processing a powder comprises (a) contacting the powder with one or more alkaline earth metal oxides, carbonates or hydroxides, or a mixture thereof; (b) combining the product of (a) with a solution of a sulphur- or phosphorous-containing mineral acid or a mixture thereof; and (c) granulating the combination of (b) to form granules.

The granulating can be carried out by breaking up the curing combination of (b) to form granules—where, for example, the combination is self-curing into a paste and then a solid and needs to be divided into smaller particles. The granulating can be carried out by agglomerating a curing combination of (b) into granules—where, for example, a mixer is used such that a damp, curing powder of small particle size is formed and needs to be agglomerated into granules of useful size. Hence, preferably the granulating takes place as the same time as, i.e. while, the combination is curing.

In carrying out the invention the acid and powder, or the alkaline earth metal compounds and the powder, are preferably mixed prior to the next step, during which, again, the combination is mixed. In (a) the mixture is preferably thoroughly mixed prior to (b). In (b) the mixture is thoroughly preferably mixed before it has cured—usually it is mixed straightaway and then allowed to cure.

As noted, in some embodiments of the invention the alkaline earth metal compound(s) is added in stages, part of it during a pre-mix step when it is combined with powder prior to adding the acid solution and part of it afterwards.

Further methods of the invention are of application where the starting powders are ashes with an inherent minimum level of alkaline earth metal oxides, carbonates or hydroxides, e.g. calcium oxide.

Accordingly, the invention provides a further method of processing an ash, said ash comprising one or more alkaline earth metal oxides, carbonates or hydroxides, the method comprising
(a) combining the ash with 2-40% by weight solution of a sulphur- or phosphorous-containing mineral acid or a mixture thereof,
(b) granulating the combination of (a) to form granules.

The level of alkaline earth metal oxides, carbonates or hydroxides in the ash is sufficient for step (a) to form a sulphate- or phosphate-containing matrix that maintains the integrity of the resultant granule and also to provide the exothermic heat that cures the combination.

The ash may already contain some alkaline earth metal oxides, carbonates or hydroxides as a result of these chemicals being added to the ash powder following incineration. Alternatively, alkaline earth metal compounds may be present in the material which is being incinerated and these may be converted to alkaline metal earth oxides in an incineration furnace and hence alkaline earth metal oxides are present in the incinerated ash.

The ash typically contains alkaline earth metal oxides, carbonates or hydroxides, in a weight of 1% or more, preferably 2% or more, more preferable 3% or more and most preferably 5% or more.

In the combining steps of the methods herein, reaction of the acid with the alkaline earth metal compound(s) is typically exothermic and results in formation of compounds that may include hydrates and hemi-hydrates that remove moisture from the mix. Hence, during this combining, the mixture cures, this curing suitably being allowed to continue for sufficient time for the mixture to set into a solid that can be broken up into granules. The exothermic heat may assist in removing moisture, and drying is therefore an optional step to obtain a dry, solid product that can be broken up or to obtain a drying product that can be agglomerated. An advantage seen in specific examples is that the method can generate sufficient heat to avoid the need for a separate drying step.

Should the reaction between the mineral acid and alkaline earth metal oxide, carbonate and/or hydroxide not result in the mixture solidifying sufficiently to allow it to be broken to form granules, the mixture can be dried further using external means (e.g. via heating the mixture). Similarly, following granulating the mixture the resultant granules can also be dried further, if desired.

Many powders, because of their small size, irregular shape or surface characteristics, are cohesive and do not flow well. Other powders because of their low sedimentation viscosity are difficult to handle and cannot be processed by automatic equipment but only carefully and slowly by hand. Granules produced from a cohesive system of the invention, however, can be larger, denser and more isodiametric, all factors contributing to improved flow properties.

The resultant granules are now useful in that they can be handled by conventional granule handling equipment or used in machines that process granular material. The starting material powders, e.g. ashes and dusts are, by contrast, difficult and in some cases practically impossible to handle this way. The granules formed by the methods of the invention can be spread by agricultural fertiliser spreading machinery.

The methods optionally comprise combining the granules with further powder, which is the same as or different to the powder of step (a), to prevent sticking and form free-flowing granules. This can aid when drying of the granules is incomplete and/or the granules are sticking. Suitably the same powder is used as for step (a).

Particle size of the granules can vary in particular with intended use. The methods may especially comprise forming granules of mass median diameter (MMD) 1 to 10 mm. Particles in this range are generally easy to handle. In preferred embodiments, the method comprises forming granules of 2 mm or more MMD, preferably up to 5 mm, and in particular in the range from 2 to 5 mm. More preferably, the method comprises forming granules having a mass median diameter of 2 mm to 3.5 mm. Such sizes are found to work well in known fertiliser and other agricultural spreading machines. Larger particles of fertiliser are not favoured by farmers, as these can generate local zones of high concentration nutrients in the field. Particle size for the granules is suitably measured using a sieve or mesh-based method, e.g. using sieves and related calibration equipment from Endecotts Ltd of London.

A range of starting material ashes can be used in the methods, and thus the powder may comprise ash, for example from combustion of one or more of bone meal, meat and bone meal, biomass, animal litter, poultry litter, chicken litter, paper, straw, offal and crematorium residue, and may include mixtures of one or more or all of these. The powder may additionally or alternatively comprise dust, for example industrial dust, industrial waste dust, dust abatement residues, cement kiln dust, potash dust and industrial flue dust, and again may include mixtures of one or more or all of these.

The powders can also have other materials included with them or added as desired to yield a more beneficial product, which for example could be plant nutrient material including nitrogenous or potassium containing materials. These are generally, but not necessarily, added to the powder before the addition of the acid. As an alternative, these materials can be added to the acid (e.g. dissolved in the acid solution) and the resulting mixture of the acid and these materials is then contacted with the powder.

In preferred embodiments of the invention the starting material is ash and/or dust that is inherently suitable, in terms of nutrient value, for use as fertiliser, but just not in a form that can be handled or spread by existing machinery. The starting material is hence substantially free from toxic components known to be unsuitable for use as agrochemical products. For example, the powders may be substantially free of high oxidation state transition metal ions (e.g. Chromium (VI) ions), halogenated cyclic compounds (e.g. polychlorinated dibenzofurans and dibenzodioxins), steroids and hormones.

Preferred powders/ashes comprise straw ash, which provides high potassium in an eventual fertiliser. Other preferred powders comprise meat and bone meal ash, due to their relatively high phosphorous content, being again useful in a fertiliser product. Still further preferred powders comprise poultry/chicken litter ash, which contains a useful mixture of both nutrients. Accordingly, in one embodiment, the ashes are meat and bone meal ash, poultry litter ash, straw ash or combinations thereof. In a particular embodiment, the starting material ash is a combination of meat and bone meal ash and poultry litter ash.

In carrying out the methods of the invention, the starting material, to be combined with dilute acid, inorganic nutrients or alkaline earth metal carbonates, oxides or hydroxides is generally substantially only ash and/or dust. In preferred methods 80% or more by weight of the starting material powder consists of the ash or the dust (or a mixture thereof), optionally supplemented by inorganic nutrients and/or alkaline earth metal carbonates, oxides or hydroxides; and more preferably 85% or more, 90% or more or 95% or more by weight, or substantially the whole weight.

An aim of the invention is to take hard-to-process powders and dusts and convert them into a useful format. The starting material powders, ashes and dusts generally are of very small size. Typically, these have a MMD of up to 1 mm, and very often below this, e.g. a MMD of up to 0.5 mm or up to 0.3 mm. The ashes are often the result of combustion of particular wastes and can contain traces of non-fully combusted (also referred to as not fully ashed) elements, e.g. straw ash can contain grains and carbonised straw, and bone meal ash can contain identifiable pieces of teeth. These may or may not be fragile. The recited mean particles sizes for the ash and dust exclude these incidental traces of the original waste.

Powders of this type are also characterised by their low density: measurable as a relatively low sedimentation velocity in air. For examples, these powders can have a sedimentation velocity of 3 ms⁻¹ or less, or of 2 ms⁻¹ or less.

In preferred embodiments of the invention, straw ash is used as starting material. This ash is found to be low density and the resulting granules are of a much higher density and as a result are easier to handle than the powder.

As described in more detail in examples below, the invention uses dilute acidic solutions in combination with the ashes and dust. The process generates heat, which aids drying of the granules. High concentration acids are not needed and the methods comprise contacting the powder with a 2-40% solution of the acid, preferably a 3-30% solution of the acid, more preferably a 4-25% solution of the acid and even more preferably a 5-20% solution of the acid. The acid is generally not strong enough to provide a chemically reductive environment and preferably no external reducing or oxidising agents are added. The strength is by weight, hence 100 g sulphuric acid in 900 g water is a 10% solution. Specific examples use about 10% acid solutions.

The acids used preferably comprise sulphuric acid, phosphoric acid or mixtures thereof. In general, other sulphur and phosphorous-containing acids can be used, including sulphurous acid, pyrosulphuric acid, ortho phosphoric acid, pyro phosphoric acid, meta phosphoric acid, polyphosphoric acids and phosphorous acid. In one preferred embodiment, the mineral acid is or comprises sulphuric acid. In another preferred embodiment, the mineral acid is a mixture of sulphuric acid and phosphoric acid.

The methods comprise mixing of the powder with alkaline earth oxides, carbonates or hydroxides or mixtures thereof or providing ashes containing alkaline earth oxides, carbonates or hydroxides. Suitable such alkaline earth materials include: burnt lime (mainly calcium oxide), calcium oxide, magnesium oxide, burnt dolomitic lime (magnesium and calcium oxides), limestone (mainly calcium carbonate), dolomitic limestone (magnesium and calcium carbonates), calcium carbonate, magnesium carbonate, calcium hydroxide, magnesium hydroxide and other minerals containing calcium and or magnesium oxides, carbonates or hydroxides.

Preferred methods comprise mixing the powder with or providing an ash with an oxide or hydroxide of calcium or magnesium, or mixtures thereof. In particularly preferred examples, the methods comprise combining the powder with, or providing an ash containing, calcium (II) oxide (CaO). CaO is readily available and adds calcium to the nutritional content. The addition of dolomitic type minerals increases the magnesium content of the resultant granules, although there is an additional cost then associated with the end fertiliser.

Granulation of the product is carried out with standard equipment, not the subject of this invention. In the examples below, 2 different granulators have been used.

The ratio of components contributes to the nutrient value in an end fertiliser product and affects the process conditions, e.g. temperature generated (which aids granule drying). The methods suitably comprise combining the powder with the acid at a weight ratio of from 1:1 to 10:1 powder: acid, more preferably combining the powder with the acid at a weight ratio of from 2:1 to 5:1 powder: acid. Some starting ashes are rather dry and are combined with relatively higher amounts of dilute acid—for example straw ash is generally combined with a greater amount of solution than is bone meal ash.

The invention provides a convenient and efficient way to render powders, dusts and ashes capable of being processed, especially into fertilisers. The end product can be used directly as fertiliser, though optionally with other nutrients added. It is preferred to carry out the method with starting material that is relatively non-toxic, so that no special detoxifying steps are needed—these would add complication and expense. The methods preferably avoid organic waste stuffs such as agricultural slurries for the same reasons.

A particular method of the invention for processing ash comprising or consisting of meat and bone meal ash, straw ash and/or poultry litter ash, comprises
(a) mixing the ash with an aqueous solution of from 5 to 30% sulphuric acid by weight in a weight ratio of 10 parts ash:1-5 parts solution;

(b) combining the product of (a) with calcium (II) oxide at a ratio of 20 parts ash:1-5 parts calcium (II) oxide, agitating the combination and allowing it to cure; and
(c) granulating the cured combination of (b) to form granules of MMD 3-10 mm.

The granules can be dusted with further ash to prevent sticking and form free-flowing granules.

The invention also provides a method of making a fertiliser, comprising a method of the invention as described. The granules produced are used in the fertilisers. Making a fertiliser may comprise supplementing the powder with a nutrient desired in the fertiliser. It may comprise supplementing the acid solution with a nutrient desired in the fertiliser, for example by dissolving the nutrient in the acid.

In the granule or agglomerated product there is a degree of controlled release of the components contained therein, as the surface area which is exposed to the solubilising substances is much less than that if it were there as a powder and the matrix of e.g. phosphate and/or sulphate further reduces leaching. The usefulness of this can be seen especially in a product for agriculture such as a fertiliser, where leachates are a significant concern.

The granules may be used for agronomic purposes, but also for construction materials, filtration and sequestration media and other purposes.

The invention is now illustrated in specific examples, with reference to the accompanying drawings in which:

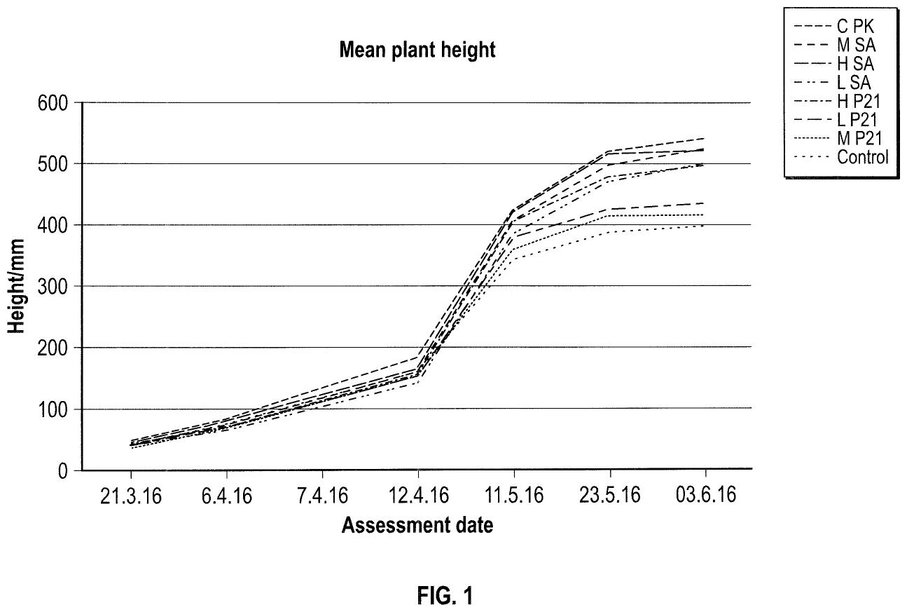

FIG. 1 shows mean height of plants tested in growing trials using fertilisers of the invention; and

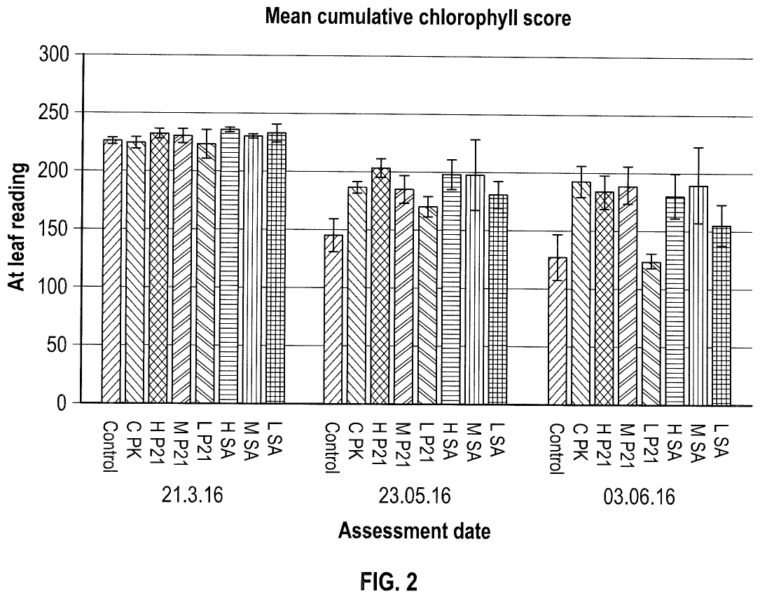

FIG. 2 shows mean cumulative leaf chlorophyll score of plants tested in growing trials using fertilisers of the invention.

### EXAMPLES

### Example 1

### Meat and Bone Meal Ash

200 g of a 10% solution of sulphuric acid was added to 500 g of finely divided meat and bone meal ash. The mixture was vigorously mixed until a homogeneous slurry was achieved, this taking about 8-10 minutes. To this was added 50 g of finely divided lime (CaO) and the slurry was continually mixed until a stiff paste was formed, again taking about 10 minutes. The paste was then broken up and granulated with the aid of a granulator giving granules of approximate size 3-4 mm diameter.

A sample of granules were removed and dusted with further bone ash powder to prevent agglomeration.

The resultant granules, although reasonably hard, continued to cool and harden over the following 2-3 hours. The granules were then ready for spreading as fertiliser.

### Example 2

### Straw Ash

200 g of a 5% solution of sulphuric acid was added to 500 g of finely divided, pale white straw ash. The mixture was then thoroughly mixed over about 6 minutes until a homogeneous paste was achieved. To this was added 36 g of finely divided lime (CaO) and continually mixed until a stiff paste was formed. The paste was then broken up through a suitable mesh, with the resultant being placed in a pan granulator for granulation.

The resultant granules produced were dark, almost black in colour, firm and continued to harden over time (about 4 hours).

### Example 3

### Chicken Litter Ash

100 g of a 20% solution of sulphuric acid was added to 500 g of finely divided chicken litter ash. The mixture was then thoroughly mixed until a homogeneous paste was achieved. To this was then added 50 g of finely divided lime (CaO) and continually mixed until a stiff paste was formed. The paste was then broken up through a mesh, with the resultant particles being placed in a pan granulator for granulation. The granules were then dusted with further chicken litter ash powder to prevent agglomeration prior to allowing to cure.

The resultant granules were firm and continued to harden over time.

### Example 4

### Meat and Bone Meal Ash (Combined Mixer/Granulator)

500 g of finely divided meat and bone meal ash was added to a high intensity mixer/granulator apparatus. 200 g of a 10% solution of sulphuric acid was added to mixer/granulator. The mixture was vigorously mixed until a homogeneous slurry was achieved, this taking about 8-10 minutes. To this was added 50 g of finely divided lime (CaO). The resultant slurry was continually mixed until the ashes agglomerated giving granules of approximate size 3-4 mm diameter.

A sample of granules were removed and dusted with further bone ash powder to prevent agglomeration.

The resultant granules, although reasonably hard, continued to cool and harden over the following 2-3 hours. The granules were then ready for spreading as fertiliser.

### Example 5

### Granule Analysis

The nitrogen, phosphorous and potassium content of each of the granules formed in Examples 1 to 3 were analysed and are shown in Table 1.

TABLE 1

| | Nitrogen | Phosphorous | Potassium |
|---|---|---|---|
| | Content (%) | Content (%) | Content (%) |
| Example 1 | 0 | 20.6 | 0 |
| Example 2 | 0 | 0 | 41.5 |
| Example 3 | 0 | 16 | 12 |

### Example 6

### Growing Trials

Materials and Methods

Formulations based on Examples 1 and 3 were tested in growing trials.

Broad beans (var Aquadulce Claudia) were established at commercial sowing rates in 5 L pots containing vermiculite plus sufficient nitrogen content to artificially create a ‘medium soil’ with a soil nitrogen supply (SNS) of 1. In order to create this ‘medium soil’ nitrogen was added as urea at a standard rate of 0.1 g per 5 L pot, based on a pot diameter of 22.5 cm, and superphosphate and potassium sulphate were added at the same rate as P₂O₅ and K₂O, respectively. This artificial ‘medium soil’ created a baseline for crop growth, as previously shown to be effective in STC study E954, and served as the negative control treatment. Inoculum (‘Legume Fix’, Legume Technology Ltd.) was also added to this substrate in order to ensure presence of beneficial bacteria for nitrogen fixation.

A negative control (i.e. no additional fertiliser) was tested alongside seven further treatments arranged within a climate controlled glasshouse. A positive control was used containing standard phosphate (P₂O₅) and Potash (K₂O) at a rate of 150 kg/ha each, following consultation with recommendations in Fertiliser Manual RB209 (Defra) for fertiliser application to broad beans grown on low fertile medium soils. Six commercial fertiliser treatments were also tested in which the P or K element was replaced by granules of Examples 1 or 3 at high, medium and low rates, where the medium rate was set to be comparable to the amount of nutrient available in the positive control. Irrigation was ad libitum and provided using mains water. Each treatment was replicated five times in a randomised block design. Treatment details are provided in Table 2. Fertilisers incorporating granules of Examples 1 and 3 above were used as specified in the Table.

TABLE 2
Treatment details, assuming an evidenced P content in P21 of 21.7% and an evidenced K
content in straw ash of 35.2%, and correcting for K present in P21 (3.18%) and P present
in straw ash (1.81%). P content of superphosphate = 18%; K content of potash = 42%.

| | | | Amount per 5 L pot^{NB} | | | |
|---|---|---|---|---|---|---|
| Treatment | Nutrients | | | Granules of | | Granules of |
| Label | added | P/K content | Superphosphate | Example 1 | Potash | Example 3 |
| Control | NPK | Baseline | — | — | — | — |
| Commercial | PK | 150/150 kg/ha | 3.33 | — | 1.43 | — |
| PK | | | | | | |
| (C PK) | | | | | | |
| P21 high | PK^{a} | 300/150 kg/ha | — | 5.53 | 1.33 | — |
| (H P21) | | | | | | |
| P21 med* | PK^{a} | 150/150 kg/ha | — | 2.76 | 1.39 | — |
| (M P21) | | | | | | |
| P21 low | PK^{a} | 75/150 kg/ha | — | 1.38 | 1.40 | — |
| (L P21) | | | | | | |
| Straw ash | PK^{b} | 150/300 kg/ha | 3.22 | — | — | 3.41 |
| high | | | | | | |
| (H SA) | | | | | | |
| Straw ash | PK^{b} | 150/150 kg/ha | 3.28 | — | — | 1.70 |
| med** | | | | | | |
| (M SA) | | | | | | |
| Straw ash | PK^{b} | 150/75 kg/ha | 3.31 | — | — | 0.85 |
| low | | | | | | |
| (L SA) | | | | | | |

*where P added should be equivalent to the ‘commercial PK’ control;
**where K added should be equivalent to the ‘commercial PK’ control;
^{a}P added via P21, K uniform;
^{b}K added via Straw ash, P uniform.
^{NB}The amount of P and K per pot has been corrected for field sowing rates, where in an equivalent field area only 0.10 of a bean plant would be grown.

A single product application was undertaken, with Mg also added evenly across all pots (0.1 g/pot) post-emergence. Products were applied immediately prior to sowing on the 08.02.16 as a surface treatment and lightly incorporated into the surface of the substrate. Five beans were initially sown per pot, though thinned to one post-emergence (to increase establishment per pot and provide data on germination).

Regular agronomic assessments were done throughout the trial period, looking for appropriate indicators of crop quality and yield (i.e. plant height, leaf chlorophyll content). At the end of the study period root and above-ground plant mass was determined and an assessment of bean yield made.

Prior to commencing the study 5 sub-samples of clean vermiculite were taken and combined as a single sample for chemical analysis by NRM. At the end of the trial samples were taken from all pots and combined into a single sample per treatment prior to sending for the same analysis. This was done to allow comment to be made on remaining nutrient in treated pots vs both baseline levels and ‘untreated’ vermiculite. This element of the work was included through sub-contract, with the projects nine samples analysed by NRM analysis package H001 (which is appropriate for vermiculite according to NRM). This entailed extraction according to BSEN13040 2000 [1:5] and was expected to produce data on “Dry Matter, Bulk Density, Dry Density, pH, Conductivity, Nitrate-N and Ammonium-N with calculated soluble N, Chloride, Sulphate, Potassium, Phosphorous, Magnesium, Calcium, Sodium, Iron, Manganese, Zinc, Copper and Boron”.

Regular observations were undertaken to record the pest and disease levels that occurred. The crops were treated, as with the standard comparison crop, with the fungicide (Signum) to control chocolate spot on the 07.04.16. No further diseases or pests were observed throughout the trial period.

At the end of the trial all remaining product provided by the funder was collected for return to the funder. This included any growing media used in the trial that was exposed to treatment with product, as well as any remaining product returned post-analysis from NRM.

Results

Plant Height

The height of each plant was measured at 7 intervals prior to harvest. The mean height for each treatment group can been seen in FIG. 1 (n=5).

Chlorophyll Content

The mean cumulative leaf chlorophyll score was measured at 3 intervals over the course of the study period for each treatment. This is shown in FIG. 2 (n=5).

Above-Ground Plant Biomass

The above-ground plant biomass and below-ground plant biomass at harvest was measured for each treatment. The mean values and standard errors are shown in Table 3 below.

TABLE 3

| | Mean Above- | Mean Below- |
|---|---|---|
| | Ground | Ground |
| Treatment | Biomass (g) | Biomass (g) |
| Control | 8.1 ± 1.5 | 27.79 ± 2.55 |
| C PK | 21.9 ± 6.4 | 30.58 ± 6.53 |
| H P21 | 17.1 ± 3.0 | 30.78 ± 0.87 |
| M P21 | 17.0 ± 3.4 | 39.73 ± 4.06 |
| L P21 | 10.9 ± 2.9 | 27.79 ± 4.04 |
| H SA | 22.4 ± 6.5 | 52.85 ± 10.86 |
| M SA | 26.1 ± 6.8 | 50.61 ± 12.71 |
| L SA | 16.0 ± 5.0 | 34.44 ± 11.11 |

Harvest Parameters

Following harvest, the number of pods, the pod weight and bean weights were measured for each treatment group. The mean values and standard errors are shown in Table 4 below:

TABLE 4

| | Mean pod | Mean pod | Mean bean |
|---|---|---|---|
| Treatment | number | weight (g) | weight (g) |
| Control | 1.2 ± 0.2 | 10.4 ± 4.3 | 4.2 ± 1.9 |
| C PK | 1.0 ± 0.4 | 24.2 ± 9.8 | 9.1 ± 3.8 |
| H P21 | 0.4 ± 0.2 | 21.3 ± 0.5 | 8.6 ± 0.4 |
| M P21 | 0.8 ± 0.4 | 15.5 ± 5.3 | 4.4 ± 1.8 |
| L P21 | 1.0 ± 0.3 | 7.8 ± 2.2 | 3.5 ± 0.3 |
| H SA | 1.4 ± 0.5 | 39.9 ± 15.6 | 15.8 ± 7.4 |
| M SA | 2.0 ± 0.8 | 27.7 ± 10.7 | 7.9 ± 3.7 |
| L SA | 1.0 ± 0.3 | 22.9 ± 12.7 | 10.2 ± 4.5 |

Chemical analysis of substrate revealed little variation between P21 and SA treatments vs the PK control (C PK) for most parameters. However, a notable exception to this pattern was seen for chloride, which appeared elevated by SA. It was clear from observations on plant growth and vigour that the increases seen had no negative impact on plants grown under the SA treatments, and could potentially be seen as beneficial given the key role of chloride as a plant micro-nutrient.

Data generally demonstrated improved performance of broad beans under the positive control treatment (with added PK) vs the negative control, as expected. This was notable for all measured above-ground growth parameters, with the exception of leaf number. Similarly improved performance of bean plants was consistently observed under experimental treatments when P21 was applied at a high rate and when SA was applied at either a high or medium rate, with low SA application also matching the positive control, particularly in terms of yield parameters. SA also appeared to have a stronger positive effect on below-ground growth parameters, with high and medium rates of SA being the only treatments that appeared to increase root fresh weight over the control, with the possible exception of P21 at a medium rate, albeit non-significantly according to the statistical analysis run. In no instance did application of either experimental treatment result in negative effects on broad beans.

Chemical analysis showed that for the majority of compounds assessed, treatment with P21 and SA had no observable effect. Nevertheless, results also suggested that use of SA may have elevated chloride concentrations within the substrate, though not at any detriment to crop growth.

The results supported that SA (using Example 3 product) offers particular potential as a K fertiliser in legume production, with benefits of SA use evidenced at all rates tested, including the lowest rate used. The added benefit might be derived from fertilising broad beans with SA as opposed to potash, where SA had apparently comparable benefits to potash, even when the SA was applied at a lower rate. As an essential micro-nutrient, increased chloride may have even contributed to the generally positive effect of SA on bean growth.

Benefits of P21 (using Example 1 product) were less apparent in the current study, where at a comparable (i.e. medium) rate to superphosphate, P21 was typically out-performed in terms of its ability to promote plant growth and yield. Nevertheless, at an increased rate the benefits of P21 fertilisation appeared similar to superphosphate, supporting its use as a fertiliser (and especially given the lower cost of P21 production and its micronutrient content).

In no instance were any negative effects on broad bean performance observed, supporting crop safety of the products used at the rates tested.

The invention hence provides methods for processing powders, e.g. ashes, to form granules that are useful in or as fertilisers.

1. A method of processing a powder, comprising
(a) contacting the powder with
(i) a 2%-40% by weight solution of a sulphur- or phosphorous-containing mineral acid or a mixture thereof, or
(ii) one or more alkaline earth metal oxides, carbonates or hydroxides, or a mixture thereof;
(b) combining the product of (a)(i) with one or more alkaline earth metal oxides, carbonates or hydroxides, or a mixture thereof; or combining the product of (a)(ii) with a 2%-40% by weight solution of a sulphur- or phosphorous-containing mineral acid or a mixture thereof and optionally with further of the alkaline earth metal oxides, carbonates or hydroxides, or a mixture thereof; and
(c) granulating the combination of (b) to form granules.

2. (canceled)

3. A method according to claim 1, wherein step (b) comprises forming granules of mass median diameter (MMD) from 2 mm to 10 mm.

4. A method according to claim 1, wherein the powder comprises ash e.g. from combustion of one or more of bone meal, biomass, animal litter, poultry litter, paper, straw, offal and crematorium residues.

5. A method according to claim 1, wherein the powder comprises dust e.g. industrial dust, industrial waste dust, dust abatement residues, cement kiln dust and industrial flue dust.

6. A method according to claim 4, wherein 90% or more by weight of the powder consists of ash.

7. A method according to claim 1, wherein the powder has a MMD of up to 1 mm.

8. (canceled)

9. A method according to claim 1 comprising contacting the powder with a 3%-30% by weight solution of the acid.

10. A method according to claim 1 wherein the acid comprises sulphuric acid, phosphoric acid or mixtures thereof.

11. A method according to claim 1 comprising combining the product of (a) with an oxide or hydroxide of calcium or magnesium, or mixtures thereof.

12. A method according to claim 1 comprising combining the powder with the acid at a weight ratio of from 1:1 to 10:1 powder:acid.

13. A method of processing an ash, said ash comprising one or more alkaline earth metal oxides, carbonates or hydroxides, the method comprising
(a) combining the ash with 2%-40% by weight solution of a sulphur- or phosphorous-containing mineral acid or a mixture thereof,
(b) granulating the combination of (a) to form granules.

14. (canceled)

15. A method according to claim 13, wherein step (b) comprises forming granules of mass median diameter (MMD) from 2 mm to 10 mm.

16. (canceled)

17. A method according to claim 13, wherein the ash comprises 2% or more of the alkaline earth metal oxide, carbonate or hydroxide or a mixture thereof.

18. A method according to claim 13, wherein the powder has a MMD of up to 1 mm.

19. A method according to claim 13 comprising combining the ash with a 3%-30% by weight solution of the acid.

20. A method according to claim 13, wherein the acid comprises sulphuric acid, phosphoric acid or mixtures thereof.

21. (canceled)

22. A method according to claim 13 comprising combining the powder with the acid at a weight ratio of from 1:1 to 10:1 powder:acid.

23-25. (canceled)

26. A method of making a fertiliser, the method comprising processing ash comprising meat and bone meal ash, straw ash, poultry litter ash and mixtures thereof, the processing comprising
(a) mixing the ash with an aqueous solution of from 5% to 30% sulphuric acid by weight in a weight ratio of 10 parts ash:1-5 parts solution;
(b) combining the product of (a) with calcium (II) oxide at a ratio of 20 parts ash:1-5 parts calcium (II) oxide, agitating the combination and allowing it to cure; and
(c) granulating the combination of (b) to form granules of MMD 2 mm-5 mm.

27. A method according to claim 1 comprising granulating the combination while it is curing.

28. A method according to claim 1, wherein the method is a method of making a fertiliser.

29-33. (canceled)
